(19) United States
(12) Patent Application Publication
(10) Pub. No.: US 2014/0190641 A1
(43) Pub. Date: Jul. 10, 2014

(54) ADJUSTABLE SAFETY GATE

(71) Applicant: Tsung-Hsiang Wang, New Taipei City (TW)

(72) Inventor: Tsung-Hsiang Wang, New Taipei City (TW)

(21) Appl. No.: 13/738,748

(22) Filed: Jan. 10, 2013

(51) Int. Cl. E06B 9/06

(52) U.S. Cl. CPC E06B 9/06
USPC 160/222

(57) ABSTRACT

An adjustable safety to has a first panel, a second panel and a fastening device. The first panel has a screw hole formed therein. The second panel has a horizon formed therethrough. The second panel partially overlaps the first panel and is slidable laterally elative to the first panel. The fastening device is used to secure the second panel to the first panel. The fastening device includes a carriage and a fastener. The carriage is slidably mounted along the slot of the second panel. The carriage has a through hole formed therein. The fastener has a threaded shank extending through the through hole in the carriage and the slot in the second panel, and selectively engaging and disengaging the screw hole in the first panel. Therefore, the safety gate is expandable and retractable to provide a variable width to suit different conditions and requirements.

### BACKGROUND OF THE INVENTION

1. Field of the Invention

The present invention relates to a safety gate, and more particularly to an adjustable safety gate that can be adjusted to vary its width to suit different conditions and requirements.

2. Description of the Related Art

A safety gate is a harrier designed to prevent children or pets from accessing certain areas of a home. The safety gate may be secured across a doorway or stairway.

However, the width of the conventional safety gate cannot be varied. Different safety gates must be purchased for different conditions and requirements.

To overcome the shortcomings, the present invention provides an adjustable safety gate to mitigate or obviate the aforementioned problems.

### SUMMARY OF THE INVENTION

The present invention provides an adjustable safety gate that can be adjusted to vary its width to suit different conditions and requirements.

An adjustable safety gate in accordance with the presentation comprises a first panel, a second panel, at least one top holder, a least one bottom holder and a fastening device. The first panel has a front surface, a top edge, a bottom edge, an inner side and a screw hole. The screw hole is formed in the front surface adjacent to the inner side of the first panel. The second panel partially overlaps the first panel and is slidable laterally relative to the first panel. The second panel has a top edge, a bottom edge and a horizontal slot. The slot is formed through the second panel. The at least one top holder holds the top edges of the first and second panels together. The at least one bottom holder holds the bottom edges of the first and second panels together. The fastening device is used to secure the second panel to the first panel. The fastening device includes a carriage and a fastener. The carriage is slidably mounted along the slot of the second panel. The carriage has a through hole formed therein. The fastener has a threaded shank extending through the through hole in the carriage and the slot in the second panel, and selectively engaging and disengaging the screw hole in the first panel. When the fastener is loosened to permit disengagement of the threaded shank from the screw hole, the carriage and fastener are freely slidable along the slot such that the second panel is free to slide relative to the first panel. When the fastener is tightened to draw the threaded shank into the screw hole, the first and second panels will be fixed in position. Therefore, the safety gate is operable to expand and retract to provide a variable width to suit different conditions and requirements.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an adjustable safety gate in accordance with the present invention;

FIG. 2 is an exploded perspective view of the adjustable safety gate in FIG. 1;

FIG. 3 is a partially exploded perspective view of the adjustable safety gate in FIG. 1;

FIG. 4 is an operational front view of the adjustable safety gate in FIG. 1;

FIG. 5 is an enlarged view in partial section of the adjustable safety gate taken along line 5-5 in FIG. 4;

FIG. 6 is a perspective view of another embodiment of an adjustable safety gate in accordance with the present invention; and

FIG. 7 is an operational front view of the adjustable safety gate in FIG. 6.

### DETAILED DESCRIPTION OF THE PREFERRED EMBODIMENTS

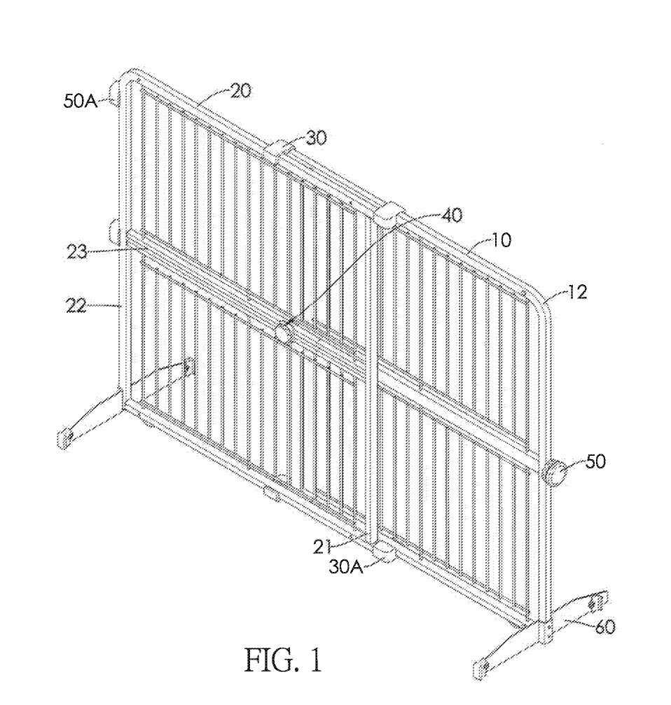

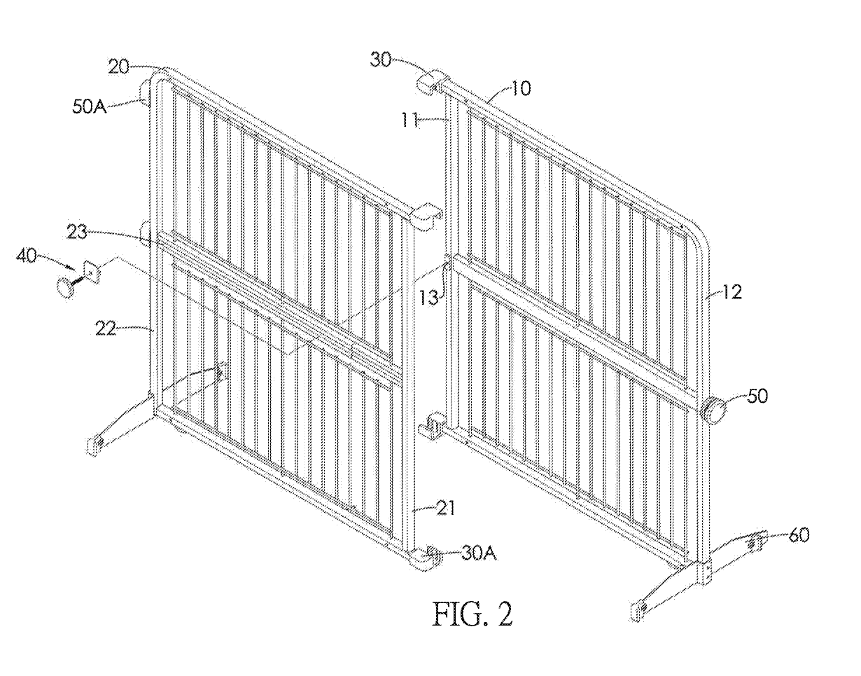

With reference to FIGS. 1 and 2, an adjustable safety gate in accordance with the present invention comprises a first panel 10, a second panel 20, at least one top holder 30, a least one bottom holder 30A, a fastening device 40, a plurality of bumpers 50, 50A and two support bases 60.

The first panel 10 may be a fence and may be constructed of metal, wood or plastic. The first panel 10 has a front surface, a top edge, a bottom edge, an inner side 11, an outer side 12 and a screw hole 13. The screw hole 13 is formed in a central portion of the front surface adjacent to the inner side 11 of the first panel 10.

The second panel 20 partially overlaps the first panel 10 and is slidable laterally relative to the first panel 10, thus varying the overall width of the safety gate. The second panel 20 may be a fence and may be constructed of metal, wood or plastic. The second panel 20 has a top edge, a bottom edge, a central portion, an inner side 21, an outer side 22 and a horizontal slot 23. The slot 23 is formed through the central portion of the second panel 20.

The at least one top holder 30 holds the top edges of the first and second panels 10, 20 together, and the at least one bottom holder 30A holds the bottom edges of the first and second panels 10, 20 together. The first and second panels 10, 20 are thus adjacent and are still slidable relative to each other. In a preferred embodiment, two spaced top holders 30 hold the top edges of the first and second panels 10, 20 and two spaced bottom holders 30A hold the bottom edges of the first and second panels 10, 20.

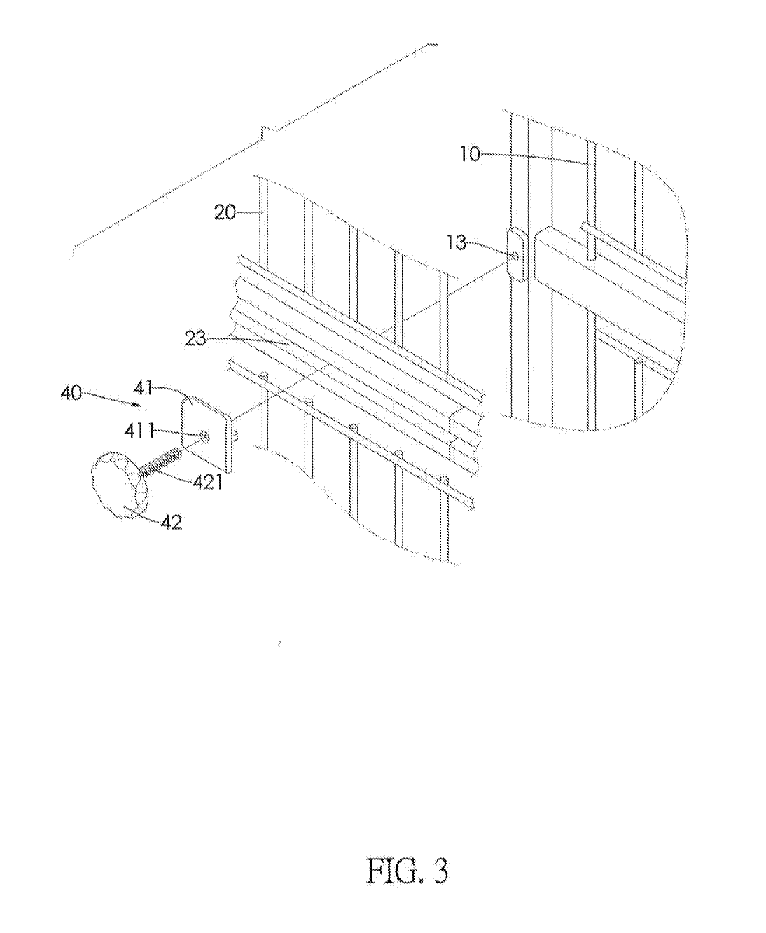

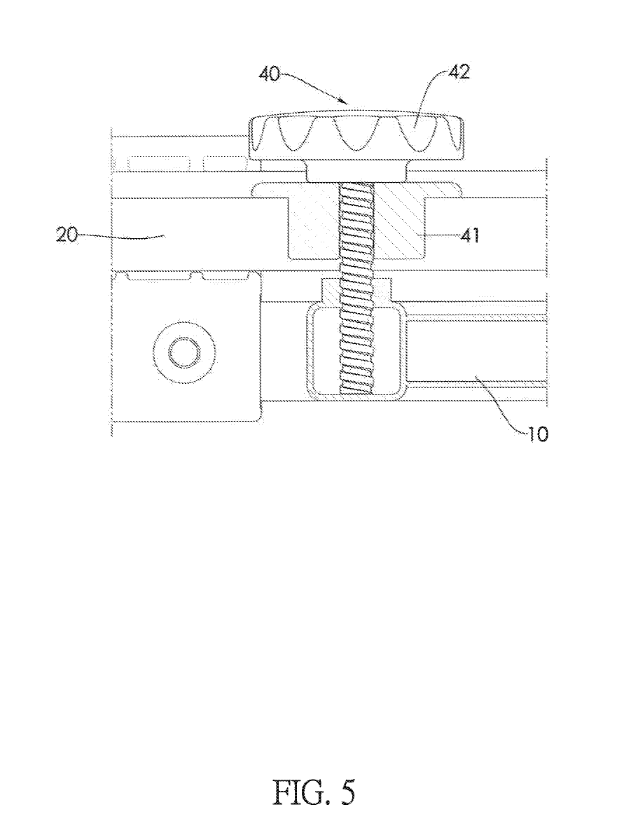

With reference to FIGS. 3 to 5, the fastening device 40 is used to secure the second panel 20 to the first panel 10. The fastening device 40 includes a carriage 41 and a fastener 42. The carriage 41 extends through and is slidable along the slot 23 of the second panel 20. The carriage 41 has a through hole 411 formed therein. The fastener 42 has a threaded shank 421 extending through the through hole 411 in the carriage 41 and the slot 23 in the second panel 20, and selectively engaging and disengaging the screw hole 13 in the first panel 10. When the fastener 42 is loosened to permit disengagement of the threaded shank 421 from the screw hole 13, the carriage 41 and fastener 42 are freely slidable along the slot 23 such that the second panel 20 is free to slide relative to the first panel 10. When the fastener 42 is tightened to draw the threaded shank 421 into the screw hole 13, the first and second panels 10, 20 will be fixed in position.

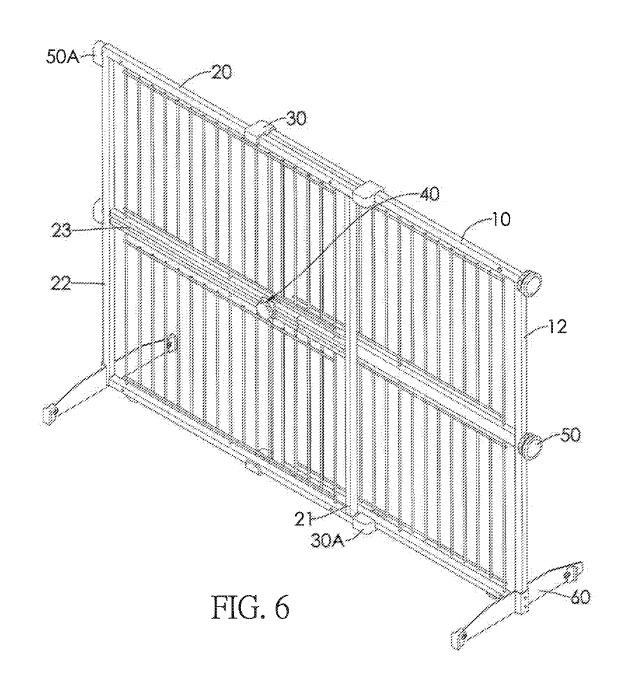

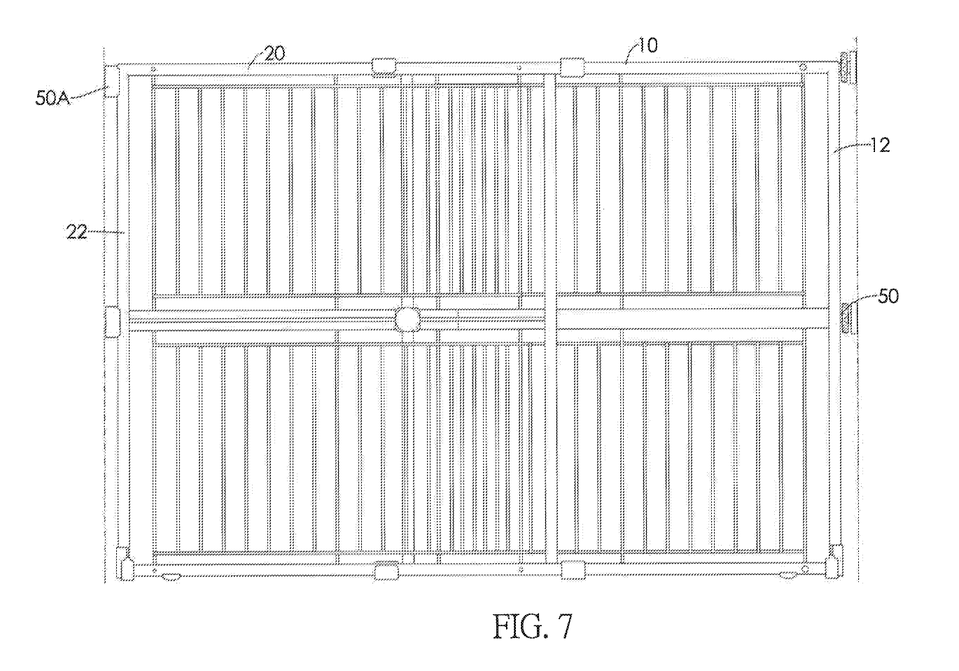

With reference to FIG. 1, the bumpers 50, 50A are attached to the outer sides 12, 22 of the first and second panels 10, 20 for contacting vertical sides of the opening to be blocked. In a preferred embodiment, one bumper 50 is attached to the outer side 12 of the first panel 10 and two spaced bumpers 50A are attached to the outer side 22 of the second panel 20. The bumper 50 on the outer side 12 of the first panel 10 may be horizontally adjustable. With reference to FIGS. 6 and 7, in another preferred embodiment, two spaced bumper 50 are attached to the outer side 12 of the first panel 10 and two spaced bumpers 50A are attached to the outer side 22 of the second panel 20. The bumpers 50 on the outer side 12 of the first panel 10 may be horizontally adjustable.

With reference to FIG. 1, the support bases 60 are secured to bottoms of the outer sides 12, 22 of the first and second panels 10, 20 respectively, thereby supporting the first and second panels 10, 20 on a floor or other horizontal. surface.

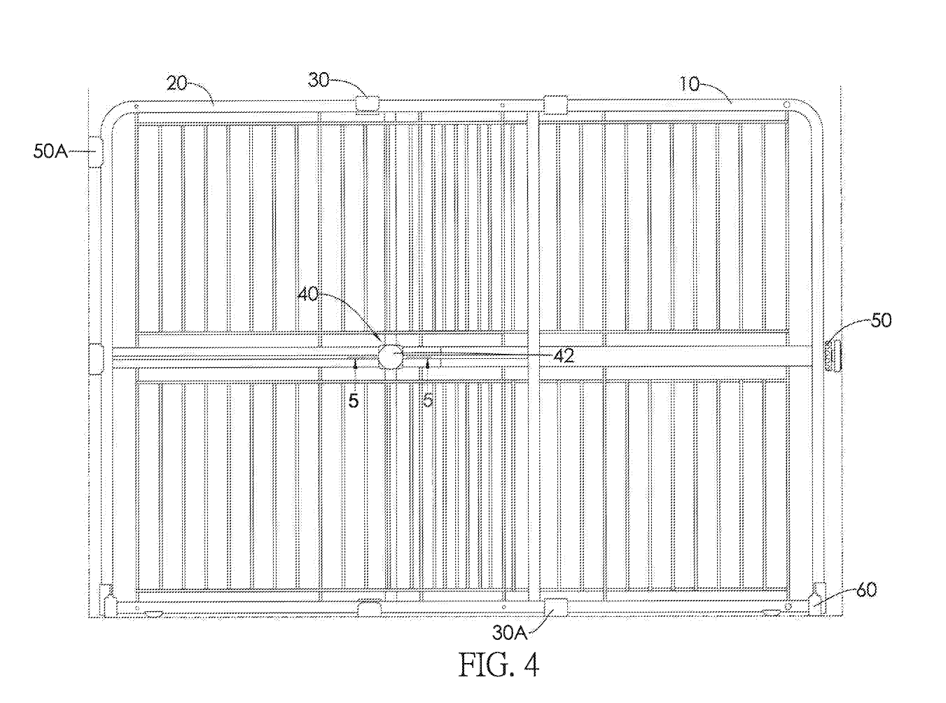

With reference to FIG. 4, to install the safety gate in an opening, the fastener 42 is loosened such that the first and second panels 10, 20 are expandable and retractable to adjust the width of the safety gate to correspond to the opening width. After the width of the safety gate has been adjusted, the fastener 42 is tightened to fix the first and second panels 10, 20. With use of the bumpers 50, 50A, the safety gate can be securely retained in the opening. Therefore, the safety gate is operable to expand and retract to provide a variable width to suit different conditions and requirements.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. An adjustable safety gate comprising:
a first panel having:
a front surface;
a top edge;
a bottom edge;
an inner side; and
a screw hole formed in the front surface adjacent to the inner side of the first panel;
a second panel partially overlapping the first panel, being slidable laterally relative to the first panel and having:
a top edge;
a bottom edge; and
a horizontal slot formed through the second panel;
at least one top holder holding the top edges of the first and second panels together;
a least one bottom holder holding the bottom edges of the first and second panels together; and
a fastening device including:
a carriage slidably mounted along the slot of the second panel and having a through hole formed therein; and
a fastener having a threaded shank extending through the through hole in the carriage and the slot in the second panel, and selectively engaging and disengaging the screw hole in the first panel.

2. The adjustable safety gate as claimed in claim 1, wherein two spaced top holders hold the top edges of the first and second panels and two spaced bottom holders hold the bottom edges of the first and second panels.

3. The adjustable safety gate as claimed in claim 1, wherein the first and second panels are fences.

4. The adjustable safety gate as claimed in claim 2, wherein the first and second panels are fences.

5. The adjustable safety gate as claimed in claim 1 further comprising a plurality of bumpers attached to outer sides of the first and second panels.

6. The adjustable safety gate as claimed in claim 2 further comprising a plurality of bumpers attached to outer sides of the first and second panels.

7. The adjustable safety gate as claimed in claim 3 further comprising a plurality of bumpers attached to outer sides of the first and second panels.

8. The adjustable safety gate as claimed in claim 4 further comprising a plurality of bumpers attached to outer sides of the first and second panels.

9. The adjustable safety gate as claimed in claim 5, wherein at least one bumper is attached to the outer side of the first panel and two spaced bumpers are attached to the outer side of the second panel.

10. The adjustable safety gate as claimed in claim 6, wherein at least one bumper is attached to the outer side of the first panel and two spaced bumpers are attached to the outer side of the second panel.

11. The adjustable safety gate as claimed in claim 7, wherein at least one bumper is attached to the outer side of the first panel and two spaced bumpers are attached to the outer side of the second panel.

12. The adjustable safety gate as claimed in claim 8, wherein at least one bumper is attached to the outer side of the first panel and two spaced bumpers are attached to the outer side of the second panel.

13. The adjustable safety gate as claimed in claim 5 further comprising two support bases secured to bottoms of the outer sides of the first and second panels respectively.

14. The adjustable safety gate as claimed in claim 6 further comprising two support bases secured to bottoms of the outer sides of the first and second panels respectively.

15. The adjustable safety gate as claimed in claim 7 further comprising two support bases secured to bottoms of the outer sides of the first and second panels respectively.

16. The adjustable safety gate as claimed in claim 8 further comprising two support bases secured to bottoms of the outer sides of the first and second panels respectively.

17. The adjustable safety gate as claimed in claim 9 further comprising two support bases secured to bottoms of the outer sides of the first and second panels respectively.

18. The adjustable safety gate as claimed in claim 10 further comprising two support bases secured to bottoms of the outer sides of the first and second panels respectively.

19. The adjustable safety gate as claimed in claim 11 further comprising two support bases secured to bottoms of the outer sides of the first and second panels respectively.

20. The adjustable safety gate as claimed in claim 12 further comprising two support bases secured to bottoms of the outer sides of e first and second panels respectively.
